(19) United States
(12) Patent Application Publication
(10) Pub. No.: US 2014/0042253 A1
(43) Pub. Date: Feb. 13, 2014

(54) CRUSHING APPARATUS AND METHOD

(71) Applicant: Roy B. Miller, Raleigh, NC (US)

(72) Inventor: Roy B. Miller, Raleigh, NC (US)

(21) Appl. No.: 13/568,567

(22) Filed: Aug. 7, 2012

(51) Int. Cl. B02C 1/06

(52) U.S. Cl. 241/27; 241/263

(57) ABSTRACT

Crushing walls arranged in opposed pairs to form a V-shaped crushing chamber each have a bar spring element arranged adjacent the outer surface thereof. Exciters, capable of providing at least 75 hp to the crushing walls, urge the spring members toward and away from each other causing the crushing walls to converge and crush material therebetween.

### FIELD OF THE INVENTION

The invention relates to devices and methods for comminuting substantially solid materials such as rock, and more particularly relates to an energy efficient device and method that utilize resonant vibrational energy to comminute such materials.

### BACKGROUND

Quarries and aggregate suppliers utilize various types of rock crushing equipment to fragment or comminute rocks into various desired sizes or grades of aggregate. Such equipment generally is classified as primary, secondary, or tertiary crushing equipment. Primary crushers include large devices that are sized to receive large rocks and boulders up to about 60 inches in diameter, and are capable of comminuting such rocks or boulders into fragments to less than about 4 inches in diameter. Smaller secondary and tertiary crushers are used to further comminute such reduced fragments to a desired final size or grade. It has therefore become common practice in quarries to perform staged reduction. In such situations rock is processed through one crusher with a reduction ratio of 2 to 4. The resulting material is then screened for age and processed through another crusher with a similar reduction ratio.

One common type of rock crusher is a jaw crusher. Jaw crushers typically include a stationary mandrel and an opposed, pivoting jaw that reciprocates between an open position and a crushing position. Rock is fed between the stationary mandrel and pivoting jaw, where the rock is compressed and crushed into smaller fragments. Jaw crushers commonly are used as both primary and secondary crushers.

Gyratory cone crushers typically include a stationary bowl or cone having substantially upright sides and an open top. A central gyrating mandrel within the bowl forms alternating open and closed gaps between the mandrel and the sides of the bowl as the mandrel eccentrically gyrates within the bowl. Rock that is introduced into the open top of the bowl is crushed between the upright sides and the gyrating mandrel as the mandrel reciprocally approaches the upright sides. Like jaw crushers, gyratory cone crushers commonly are used as either primary or secondary crushers.

Roll crushers primarily are used as secondary or tertiary crushers due to their characteristically low reduction ratios. Roll crushers include a plurality of spaced and opposed rolls. Opposed rolls rotate in opposite directions and form a crushing region between the rolls. The rolls may have substantially smooth outer surfaces, or may include cooperating spaced teeth or picks.

Unlike the compressive crushing action of jaw crushers, gyratory cone crushers, and roll crushers, impact crushers crush rock by imparting sudden impact forces to the rock. Horizontal shaft impact crushers typically include one or more rotating horizontal shafts having a plurality of outwardly extending arms or paddles. As the horizontal shafts are rotated at high speeds, rock is fed to the paddles and shattered by the rock's impact with the rapidly moving paddles. Horizontal shaft impact crushers commonly are used as primary, secondary, or tertiary crushers. Because of the high impact forces that are characteristic of such crushers, these devices require substantial periodic maintenance. Vertical shaft impact crushers include a central spindle or drum that is rotated at high speeds. As rock is fed to the center of the rotating spindle, the rock is centrifugally cast at high velocity against a surrounding ring of anvils, where the rock is shattered into fragments. Vertical shaft impact crushers primarily are used as secondary or tertiary crushers.

All of the traditional types of rock crushers described above include electric motors to directly drive the various types of crushing mechanisms. Due to the large amount of energy required to crush or shatter rock, such electric motors necessarily consume substantial amounts of electric power during operation. Accordingly, the traditional forms of rock crushing equipment described above are not energy efficient. In other words, such devices use brute force to break rock, and require large energy inputs to attain such substantial crushing forces.

Others have attempted to improve the energy efficiency of rock crushing equipment by harnessing the amplified vibratory motion and vibrational energy of various resonant spring-mass systems. For example, U.S. Pat. No. 4,387,859 to Gurries describes a resonantly-powered rock crusher that includes two opposed, elongated pendulous beams having cooperating crushing jaws located at their lower ends. The upper ends of the beams are pinned to a frame such that the beams swing on the frame in a common plane. Oscillatory drivers at the upper, pinned ends of the beams synchronously drive the beams 180 degrees out of phase with each other such that the crushing jaws converge toward and diverge away from each other. The system is driven at a frequency that is slightly below the resonant frequency of the pendulous beams. Unfortunately, such a device has several shortcomings. First, the massive pivotally supported beams described and shown in this patent characteristically must have high natural frequencies and low amplitudes of vibration. Such low amplitudes limit the maximum separation of the crushing jaws, and thereby limit the size of rock that can be introduced between the jaws for crushing. In addition, the oscillatory drivers used to actuate the resonant system necessarily induce forces in the beams that are often misaligned with the beams' swinging motions. Such forces necessarily induce undesirable stresses in the beams, bearings, and frame. Furthermore, only a small fraction of the electric energy supplied to the oscillatory drivers is effectively transferred to the beams for crushing rocks. Accordingly, such a system is less energy efficient than desired.

U.S. Pat. No. 4,026,481 to Bodine describes another rock crushing device that includes two opposed jaws mounted on a pair of opposed horizontal bars. The bars are substantially simply supported at spaced intervals, and are independently driven such that the bars synchronously resonate in a lateral mode. A resonant frequency excitation sets up a standing wave in the bars. The jaws are located on the bars' vibrational antinodes (maximum deflection), and the bars are supported on their vibrational nodes (minimum deflection). This device also appears to include several shortcomings. The device uses independent rotating eccentric weights to excite the bars to resonance. Though the rotating weights induce useful horizontal excitation forces that are in plane with the desired standing waves of the bars, the rotating weights also induce cyclic out-of-plane forces that act to deflect the longitudinal beams in a vertical direction.

U.S. Pat. No. 7,237,734 to Miller is directed to a crushing apparatus that includes a substantially U-shaped spring member having a first beam portion with a first free end, a second beam portion with a second free end, and a fixed center portion. The first and second free ends are in opposed, spaced relation with each other. A first crushing mass is positioned on the first free end, and a second crushing mass is positioned on the second free end of the spring member. An exciter or power module is configured to excite the first and second beam portions at about a common first modal frequency. When so excited, the first and second crushing masses reciprocally converge toward and diverge away from each other.

The Miller patent also describes an apparatus for crushing a material that includes a first elongated beam having a first fixed end and a first substantially free end. The apparatus further includes a second elongated beam having a second fixed end and a second substantially free end. A first crushing member is on the first substantially free end of the first beam, and a second crushing member is on the second substantially free end of the second beam. The second crushing member is positioned in opposed space relation with the first crushing member. At least one beam exciter excites the first beam and the second beam in a substantially common plane in a cantilever beam mode of vibration about a common modal frequency of the first and second beams, thereby causing the first and second crushing members to reciprocally converge and diverge from one another.

In addition, Miller includes an apparatus for fragmenting a substantially brittle material that includes a first cantilevered beam having a first fixed end and a first free end. A first crushing head is on the first beam proximate to the first free end. That apparatus further includes a second crushing head, and beams for exciting the first cantilevered beam at about a first modal frequency of the first cantilevered beam. When so excited, the first crushing head reciprocally converges toward and diverges away from the second crushing head, whereby brittle material positioned between the first and second crushing heads is at least partially fragmented.

### SUMMARY OF THE INVENTION

While the spring-mass system described in the Miller patent achieves certain improvements of earlier crusher systems, it is large and heavy. As a result it has been realized that certain advantages can be achieved by supporting opposed spring elements, whether bars or plates, at their ends with the crushing members or masses placed against the spring plates in the central portion between the ends. According to one aspect then, exciters in the form of eccentric rotating masses which power the crushers are arranged in opposed pairs on opposite sides of the spring elements also in the central portion thereof. The rotating eccentric masses, capable of providing at least 75 hp, to the system then urge the spring elements (and crushing members) toward and away from each other against the rocks, causing the crushing action.

In another aspect, while the opposed spring elements are still bars or plates supported near their ends and the crushing masses placed adjacent to the central portion, hydraulic or pneumatic pistons or electromagnets working together, and again capable of providing at least 75 hp to the system, alternately urge the spring elements (and crushing members) toward and away from each other crushing the stones therebetween. In either of the aspects described above, the crushing apparatus, as described herein, is capable of achieving a quality crushed product in one pass, as opposed to the common practice in quarries of performing a two-stage reduction.

Thus the use of the spring plates supported at each end with the crushing members mounted adjacent the central portion and being urged toward and away from each other by exciters capable of providing an input of at least 75 hp to the system is a basic aspect of the invention. The invention further includes a method of crushing a substantially solid material by providing a first spring-mass system which includes a first spring and a first crushing mass, in which the first spring-mass system has a first modal frequency of vibration and a first vibration node. A second spring-mass system with a second spring and a second crushing mass is also provided, wherein the second spring-mass system has a modal frequency that is substantially equal to the first modal frequency of the first spring-mass system. The second spring-mass system has a second vibration node that is substantially coincident with the first vibration node and is harmonically coupled to the first spring-mass system. The first and second spring mass systems are excited such that the first and second spring mass systems are caused to vibrate 180 degrees out of phase with each other at a frequency as substantially equal to the first modal frequency, thereby causing the first and second crushing masses to reciprocally converge and diverge. The method further includes supporting the springs in the form of spring plates at their ends, and exciting the central portion of the springs toward and away from each other. A solid material is introduced between the reciprocally converging and diverging first and second crushing masses, thereby causing at least a portion of the solid material to be at least partially fragmented there between.

These and other aspects of the invention are described in the following detailed description and drawings.

### BRIEF DESCRIPTION OF THE DRAWINGS

FIG. 1 is a perspective view of a crushing apparatus according to the invention;

FIG. 1A is a top view of the crushing apparatus of FIG. 1;

FIG. 2 is a perspective view of the crushing plates of the apparatus of FIG. 1 alone;

FIG. 3 is a perspective view of the crusher plate support system for the apparatus shown in FIG. 1;

FIG. 4 is a perspective view of the crusher plates with the adjacent springs;

FIG. 5 is a perspective view of a spring plate alone illustrating a construction thereof;

FIG. 6 is a cross sectional view taken along lines 6-6 in FIG. 1 illustrating the relationship between the motor drive shaft, the gears, and the eccentric masses; and

FIG. 7 is a perspective view of one end of the apparatus of FIG. 1 illustrating the manner in which the spring supports are moveable away from each other to extricate large uncrushed stones.

### DETAILED DESCRIPTION OF A PREFERRED EMBODIMENT

By way of an overview, this is a rock crusher that takes large rocks in through the top of a crushing chamber, repeatedly impacts and compresses the rock between two rapidly moving crusher walls, and allows the rocks, as they become smaller, to exit the bottom gap. The rock crusher is formed by a set of opposed crusher walls that crush rock between them. The crusher walls form a V-shaped crushing chamber that takes large rocks in at the top and drops crushed rocks out the bottom. A drive section that provides at least 75 hp to the system moves the two walls toward and away from each other with enough velocity and force to crush rock in the chamber. The two massive walls and the single spring system that supports the walls make a two mass, single spring system that stores the energy for the crushing wall displacement in motion. The energy in this motion comminutes rocks, and the energy expended in each cycle is replaced by the drive section. An important aspect of this invention is the spring system that includes opposed bars or plates that are supported at each end with the V-shaped crushing chamber there between. Then as the central portion of the spring sections are excited, the walls of the V-shaped crushing member are caused to move toward and away from each other as described above. This arrangement is much smaller and more efficient than previously known systems.

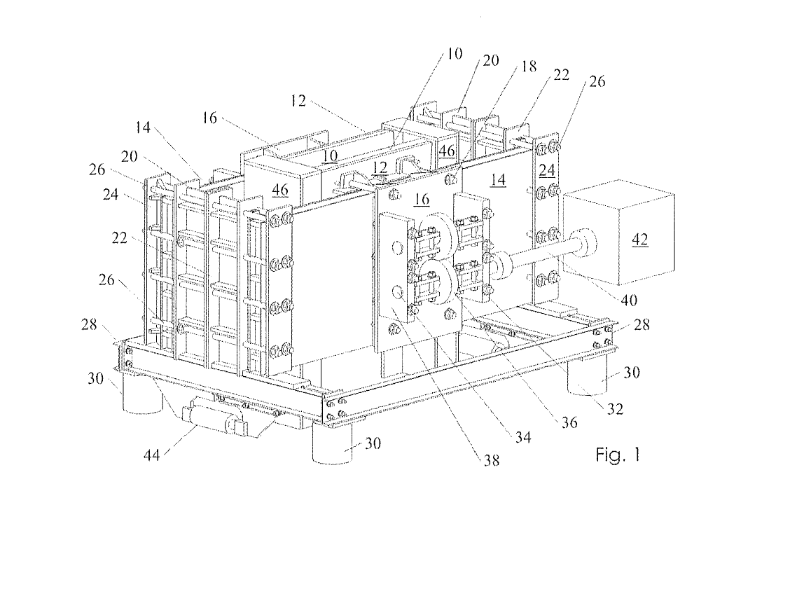

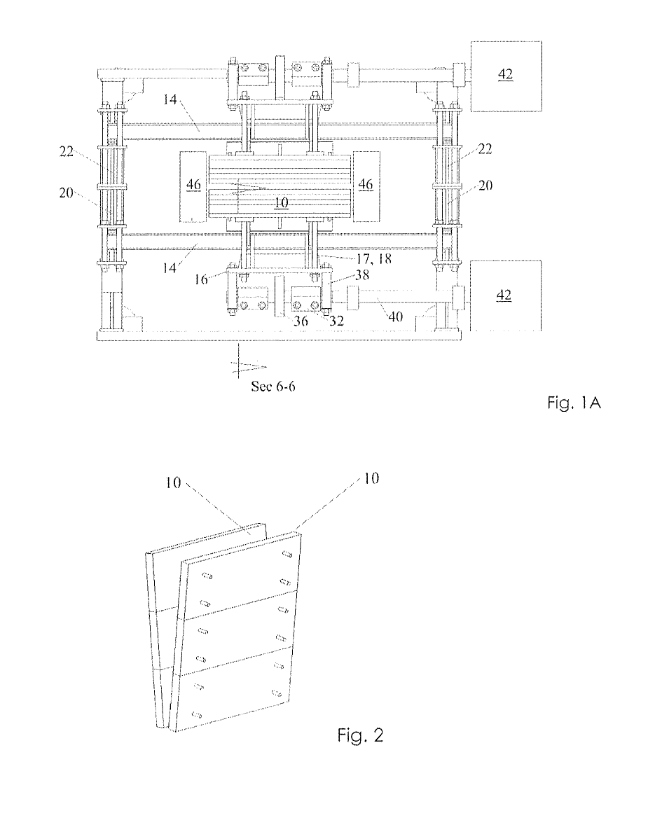

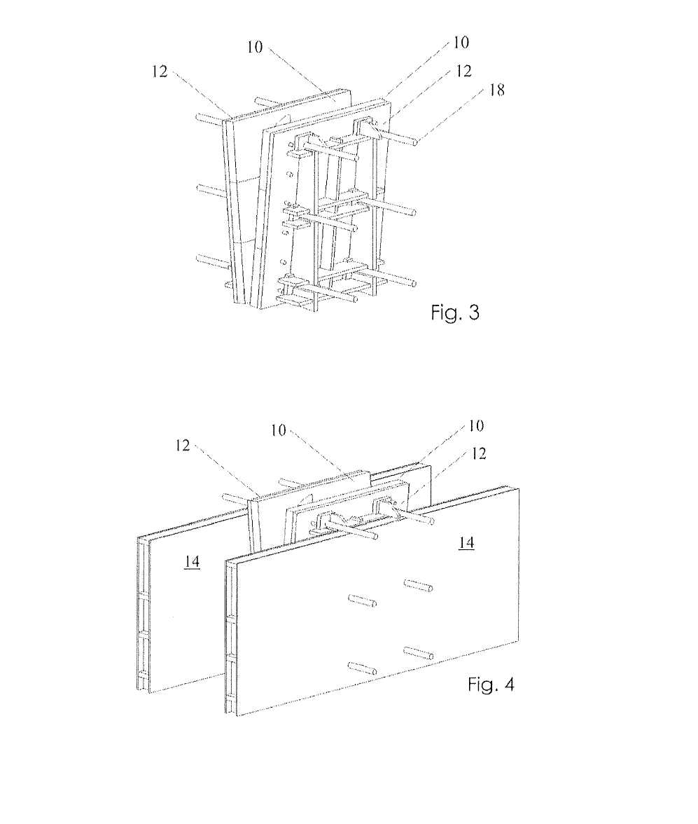

FIG. 1 is illustrative of the crusher. As mentioned above, the center of a unit includes two sets of opposing crusher plates 10 forming two walls with the rocks being crushed between them. See FIG. 2. The crusher plates form a V-shaped crushing chamber that accepts raw large rocks at the top and drops crushed small rocks out the bottom. The two crusher plates move toward and away from each other with enough velocity and force to crush rock between them in the chamber. The crusher plates 10 are supported by crusher support section 12 (FIG. 3) that holds the crushing plates against the center of the large spring beam 14 (FIG. 4), thereby supporting each crusher support section 12 and crusher plate 10.

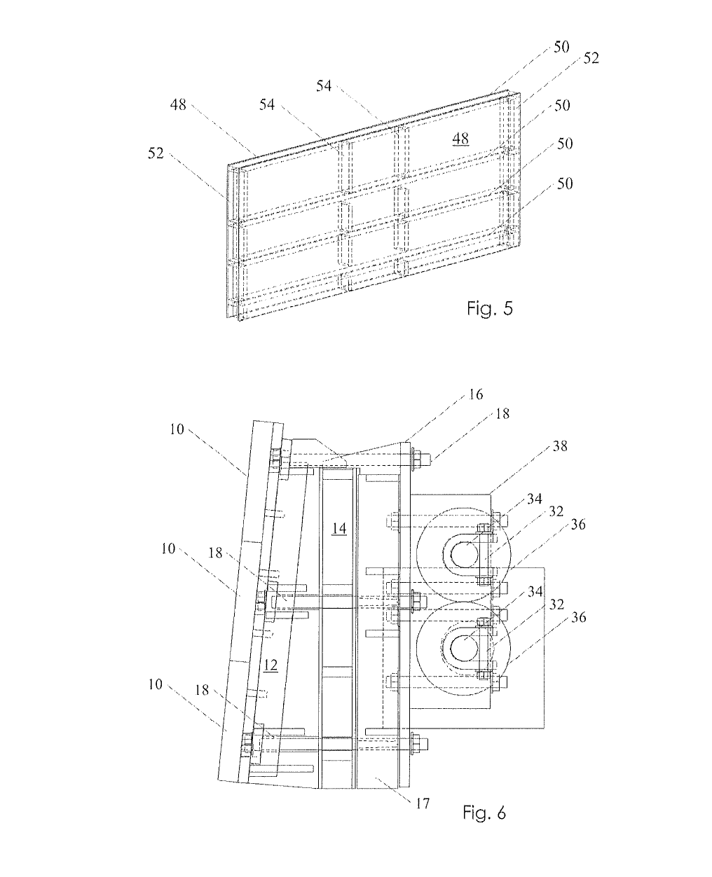

An elongated spring 14, in the form of several parallel bars 54 (FIG. 5) separating two or more plates 48 is maintained in engagement with the crusher support section 12 by a drive support section 16 (See FIG. 6). Each drive support section and crusher support section are held together with the spring 14 therebetween by means of six spring mount bolts 18. The drive support section holds the power input mechanism for the crusher. The drive support section 16 and crusher support section 12 are attached to each other on opposite sides of each spring beam and effectively clamp the spring beam between them, although the spring is free to flex. The two ends of each spring beam 14 are supported by the spring support sections 20, 22 at each end. Two vertical legs, in the form of rectangular plates, 17 (FIG. 6) are attached to the rear of drive support section 16 and extend between the drive support section 6 and spring beam 14. These legs actually engage and flex the spring beam 14 during each cycle of the drive.

The spring beams 14 are held at their ends by the fixed spring support section 20 on one spring beam and a moveable spring support section 22 on the other spring beam. This structure is at either end of the spring beams 14. The spring support sections form a stiff structure holding the spring ends on each side tightly together. This makes the spring beams work in unison and act as a single spring. The springs are held to the spring support section at each end by a spring end clamp 24. Eight large spring end bolts 26 extend through the spring end clamps on each side of the crusher and tension the spring end clamps tightly to the spring ends.

The spring end supports 20, 22 rest on the base section 28. The fixed spring support sections 20 are welded to this base section. The base section holds the movable spring support sections 22, but will allow the moveable spring support section to slide along the base section under the corresponding spring support sections. As will be explained later, this allows moving the crusher plates apart for the removal of uncrushable material that will not crush. The base 28 then rests on four isolation mounts 30 that are formed of a vibration isolation material or other construction which may permit some horizontal motion of the base structure while maintaining vertical support for the base structure. These isolation mounts permit the base and, through the base, the spring support sections and spring ends to move in a direction parallel to the spring end bolts and through this motion transfer crusher wall mass and spring deflection energy between the two opposing crusher walls as described above. The isolation mounts also hold the crusher in its location and isolates some of the crusher vibrations from the support structure below.

Power is necessary to provide torque to the shafts carrying the eccentric mass. The torque pushes the eccentric mass ahead of the wall motion continuously so the eccentric mass rotates once while the walls move back and forth once. The eccentric mass motion is strongly influenced by the acceleration forces from the walls back and forth motion and this forces the shaft to rotate once for each back and forth of the wall. The forces cause the two motors (one on each of two walls) to rotate into a synchronous position with each other and to rotate at the same speed and relative phase between the force vector from the eccentric mass and the velocity vector of the wall motion as advanced by the amount of torque.

Additional power at a given speed provides more torque to the shaft, causing the shaft to push harder against inertia and the eccentric mass. This causes the force from the rotating eccentric mass to push harder against the crusher wall motion as the wall and spring move in the direction of the eccentric mass force. This force pushing against the motion increases the energy in the crusher's spring-mass system, needed to maintain the motion between the two walls.

The wall's motion may be represented by a vector, and a velocity vector would resemble a sine wave. The back and forth force from the rotating eccentric mass would also resemble a sine wave. If the crusher is coasting, no torque is provided to the shaft, and the force vector is caused by friction forces and therefore would lag behind the wall velocity vector, removing energy from the system. Apply torque to drive the shaft and the force vector leads the velocity vector by the amount dictated by the amount of torque. The energy added by the force to the wall motion is a function of the sine of this angle. More torque moves the force vector further ahead of the wall velocity vector up until the angle is 90 degrees. A proper selection of the amount of eccentric mass and other parameters would cause the angle to never exceed 90 degrees.

The amount of energy the eccentric mass is able to push into the wall motion will be limited by the power of the driving motor. This statement applies when the system is correctly designed with the proper amount of eccentric mass for the speed and torque. The amount of rock processing that can occur in the crusher is therefore limited by the torque of the driving motors, as the amount of energy added by the motors must equal or exceed the amount of energy consumed by the rock comminuting. It has therefore been determined that at least 75 hp must be generated by the system in order for this apparatus to be effective as a commercially viable unit.

One preferred method to power the crusher is to use eccentric masses 32 mounted on two or more shafts 34 connected by gears 36. Bearing housings 38 secured to and extending from the drive support section 16 support the shafts 34. The shafts are powered through a drive shaft 40 extending from an electric motor 42. The electric motor 42 is preferably a 4 pole, 1800 revolution per minute, 480 volt alternating current industrial motor on a 405 T frame. It is capable of generating up to 100 horsepower and is totally enclosed and cooled by an enclosed fan. There is a cooperating motor 42, rotating shafts 34, gears 36, and eccentric masses 32 attached to the backside drive support section 16, which are not visible in FIG. 1, but which can be seen in FIG. 1A.

The forces from the eccentric masses on the shafts drive the crusher walls or plates 10 and springs 14 at the spring centers through the bearing housings 38 and the drive support plates 16. Legs 17 on the backside of the drive support plates actually engage spring beams 14 causing them to flex. As a result the spring 14 at the spring center moves the crusher walls toward and away from each other, thereby creating the force that crushes the rock therebetween. The two shafts on one side of the crusher rotate in opposite directions of each other as a result of the gears 36. This causes the sum of the forces from the pair of vibrating shafts on either side to be a relatively sinusoidal back and forth force that leads or follows the walls motion. Therefore the phase between the eccentric masses and the wall motion will be the same for each shaft assuming the same torque and the other parameters are equal.

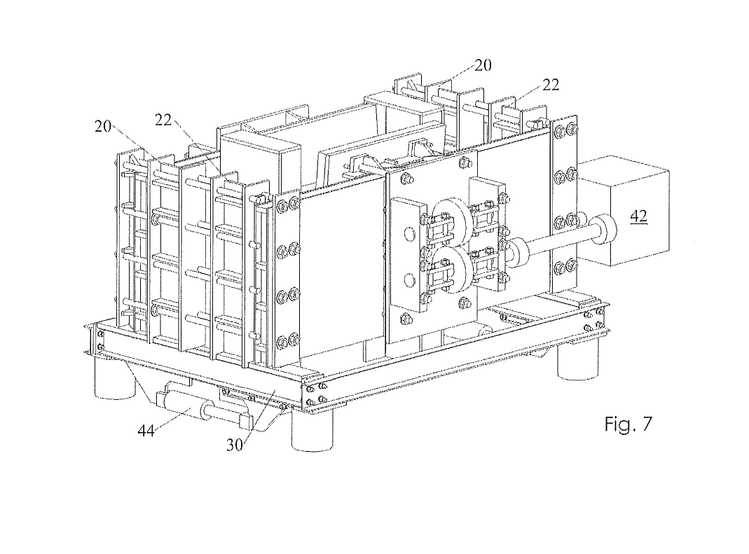

As stated above, spring support 22 is selectively moveable away from fixed spring support 20 by force from a hydraulic cylinder or power screw 44. This allows the crushing plates to be moved to an open position (FIG. 7) and larger uncrushable material to fall there through should the occasion arise that such action is necessary.

FIG. 2 is illustrative of the interior of the crusher chamber and includes in this case three crusher plates 10′, 10″, and 10′″. These walls move back and forth in a designed and controlled displacement and frequency. They are faced toward the crushing chamber and may be designed to effect the size and shape of the resulting product. Each crushing chamber side wall 46 is a shallow steel box enclosing the ends of the crusher plates 10 with an open side toward the crushing chamber. Baffles (not shown) in the box formed by side walls 46 guide rocks back into the chamber.

FIG. 3 shows the crusher support section 12 which holds the crusher plates 10 through mounting bolts 18 in turn extending through the crusher plate support section 12. The crusher support section bears against spring 14 along two vertical lines through the six spring mount bolts 18, and is compressed against the spring by the spring mount bolts.

FIG. 4 shows the crusher support section 12 bolted to the center section of the large spring beam 14. The spring mount bolts 18 protrude through the spring beam 14 and the drive support section 16 (FIG. 1) and compress these sections together. The weight of the crusher support section and the drive support section are carried by the spring beam, and they become the spring mass system that stores energy for comminuting rock.

FIG. 5 shows the spring beam 14 used in this crusher. The spring beam is a box beam design and consists of two large steel plates 48 separated by a gap created with four horizontal spars 50. The beam also has two vertical ribs 52 near the ends of the spring beams and two vertical ribs 54 near the center of the spring beam. The vertical ribs 52 maintain the gap between the two large steel plates 48 supporting the spars 50, and transmit the compression forces from the eight large spring end bolts 26 through the spring end clamps 24 into this section of the spring beam. The spring end supports 20, 22 carry this force through the center of the crusher to the spring ends on the opposite side. The two vertical ribs 54 about the center of the spring beam 14 support the spars and carry the compressive forces from the six spring mount bolts through the drive support section 16 and the crusher support section 12. The only locations the drive support section and the crusher section bear against the spring beam are on these two vertical legs. It should be noted here that, while plates 48 are illustrated as being a single expanse, plate 48 could also be made up of 2 or more smaller, horizontally extending plates.

FIG. 6 is a sectional view taken through one crusher wall and illustrating the two eccentric drive shafts 34 on one side of the crusher. The crusher plate 10 is bolted to the crusher support section 12 mounted in the center of the large spring beam 14 that also supports the drive support section 16 through the legs 17. The bearing housings 38 support the shafts 34. The gears 36 make the two shafts rotate in opposite directions. The eccentric weights 32 are oriented at similar locations on their corresponding gear, thus creating a total force that sums the forces from the two shafts in the horizontal directions (right-left as shown) and subtracts the forces, canceling to each other out, in the vertical direction (up-down). These forces contribute to the velocity of the spring mass system as the walls oscillate back and forth and replace energy consumed during the comminuting of the rocks.

On the rare occasion some uncrushable material gets into the crushing chamber, the chamber can be opened so that the bottom is then wider than the top inlet width under operating conditions. This opening is accomplished by removing one nut from each spring end bolt. This frees the moveable spring support 22 to slide down the base 30, and the hydraulic or screw cylinder 44 provides the force necessary to push the moveable spring support open and the force to close the moveable spring support. The crusher is shut down and locked out during this entire opening and closing procedure.

As the springs 14 vibrate, the crushing walls 10 reciprocally converge and diverge. One or more rocks or bodies are deposited into the upper portion of the crushing zone between the crushing walls 10 to be crushed or comminuted. As the springs 14 and crushing walls 10 converge, the rock is impacted by and at least partially compressed between the converging crushing walls 10, thereby fracturing the rock into a plurality of fragments. As the crushing walls recoil and separate from each other, the rock fragments drop lower in the crushing chamber, and again are impacted and compressed between the crushing walls. The rock fragments are thereby crushed into progressively smaller pieces as they move downwardly in the crushing region. As the process continues, crushed rock aggregate eventually falls from the crushing zone to a collection area beneath the crushing chamber. In operation, a plurality of rocks 60 may be continuously fed through the crushing chamber to produce aggregate.

The cyclic displacements of the opposed crushing walls 10 are induced by simultaneously exciting both springs 14. Energy and friction losses cause the amplitudes of spring vibration to gradually diminish over time. In operation, the eccentric masses drive the support sections 16 to maintain the amplitudes of vibration at desired levels.

The crushing apparatus is highly energy efficient compared to common compressive rock crushing equipment. During operation, the crusher stores energy in its spring-mass systems. The crusher translates this stored energy into momentum of the crushing members, which acts to crush the rock. Accordingly, the device introduces substantial impact energy into rock with little energy loss. Such an impact crushing process is believed to consume much less energy than common compressive crushing processes. In addition, the high frequencies and high amplitudes that can be achieved by the device permit the crusher to be used to fracture both large and small rocks.

A crusher according to the invention may be configured to operate at substantially any desired frequency of vibration by varying the stiffness and/or mass of the resonant spring-mass system. Higher frequencies will yield a smaller product more effectively than lower frequencies. A system according to the invention is believed to operate particularly effectively at modal frequencies that are less than or equal to about 100 Hz. Operating frequencies in a range from about 10 Hz. to about 40 Hz. are believed to be particularly effective for crushing rock. Much higher frequencies may be used for other products and other product size requirements.

The resonant crusher has properties that allow the use of higher reduction ratios in one pass, and, with adequate power, would be capable of doing the work of two machines, thus providing huge benefits to the quarry. These properties are:
Uses both impact and compression crushing techniques, something no other crusher does,
Uses V-shaped crushing chamber that is self sorting and avoids over crushing, small rocks exit without further action,
The operator controls the deflection and thus exit size in real time avoiding under crushing and over crushing

If the available power is enough to allow “choke feeding” the inlet of the crusher then the crusher has adequate power. Doubling the reduction ratio would double the power required; actually more than double since larger rocks are easier to reduce than smaller rocks, because of existing fractures and wear areas in larger rocks.

Moving the motors off the crusher wall and using eccentric shafts on the walls allows the use of more efficient electric motors. The eccentric shafts mounted on the walls require large bearings and shafts for reliability, but the overall mounted weight is much lower than with the motor.

The above descriptions of various embodiments of the invention are intended to illustrate various multiple aspects of the invention, and are not intended to limit the scope of the invention thereto. Persons of ordinary skill in the art will recognize that various modifications may be made to the described embodiments without departing from the invention. For example, though the described embodiment utilizes rotating eccentric masses operated by large (200 hp) motors to generate the torque and force necessary for crushing objects such as rocks, this force might also be attained by utilizing hydraulic or pneumatic pistons or electromagnets appropriately positioned between the opposed springs or adjacent the outer surface of the opposed spring walls and operated synchronously.

What is claimed is:

1. Apparatus for crushing a material such as rock comprising:
a) a first spring member having inner facing and outer facing surfaces fixed at each end forming a central spring section;
b) a second spring member having inner facing and outer facing surfaces fixed at each end forming a central spring section;
c) the inner surfaces of the first and second spring members being spaced apart;
d) a first crushing member positioned adjacent the central portion of the inner facing surface of the first spring member;
e) a second crushing member positioned adjacent the central portion of the inner facing surface of the second spring member and in opposed spaced relation with the first crushing member;
f) the first and second crushing members arranged at an angle with respect to each other forming a V-shaped crushing chamber that takes in large pieces of material at the top and drops crushed pieces of material on the bottom; and
g) at least two exciters, the total providing at 75 horsepower and operatively engaging the first and second spring members and configured to excite the first spring member and the second spring member toward and away from each other at a common modal frequency, thereby causing the first and second crushing members to reciprocally converge and diverge crushing the material therebetween.

2. Apparatus according to claim 1 wherein each exciter is an eccentric rotating mass positioned adjacent the outer facing surface of the central spring section of one of the first and second spring members.

3. Apparatus according to claim 2 wherein the a drive support section is positioned adjacent and in selective engagement with the central spring section of each spring member, each drive support section being movable toward and away from the adjacent spring member by the rotating mass.

4. Apparatus according to claim 3 wherein each eccentric rotating mass comprises at least one rotating shaft journaled in the drive support section and having a mass connected off-center thereof, whereby as the shaft is rotated, the eccentric mass causes the drive support section to move toward and away from the adjacent spring member.

5. Apparatus according to claim 4 wherein each drive support section includes two of the eccentric masses, each eccentric mass being carried by a separate rotating shaft, the rotating shafts each carry a gear with the gears connecting the shafts for synchronous rotation in opposite directions.

6. Apparatus according to claim 1 wherein the exciters are pistons engaging the outer facing surface of the central spring section of the first and second spring members and working together to alternately urge the spring members toward and away from each other.

7. Apparatus according to claim 1 wherein the exciters are electromagnets engaging the outer facing surfaces of the central spring section of the first and second spring members and working together to alternately urge the spring members away from and toward each other.

8. A method for crushing material such as rock to a final size in a single stage comprising the steps of:
a) introducing the material between first and second crushing walls arranged to form a V-shaped crushing chamber and having the outer surface of each crushing wall being arranged for engagement by the central portion of inner surface of a spring member secured at each end; and
b) continuously exciting the central portion of the spring members by at least 75 hp causing the first and second crushing walls to reciprocally converge and diverge crushing the material therebetween.
